(19) United States
(12) Patent Application Publication
(10) Pub. No.: US 2008/0258699 A1
(43) Pub. Date: Oct. 23, 2008

(54) Converter Circuit with Improved Efficiency

(75) Inventors: Jacques Reberga, Saint-Loup-de-Fribois (FR); Melaine Philip, Blainville/Orne (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/577,314

(22) PCT Filed: Sep. 7, 2005
(86) PCT No.: PCT/IB05/52915

§ 371 Date: Mar. 6, 2008

(30) Foreign Application Priority Data
Oct. 15, 2004 (EP) 04 300 682.4

(51) Int. Cl. G05F 1/00

(52) U.S. Cl. 323/285

(57) ABSTRACT

The present invention relates to a converter circuit and a conversion method for converting an input signal to an output signal of a predetermined value based on a switched operating mode, wherein a first control loop (40) is provided for comparing the predetermined value of the output signal to a first reference value and for generating a feedback signal in response to the comparison result; and wherein a second control loop (60) is provided for comparing a time period passed until the feedback signal is generated to a second reference value and for controlling the switching parameter of the switched operating mode in response to the comparison result. As a result, the output signal is correctly controlled not only with respect to the output load but also over a wide range of the input signal, so that power efficiency and reliability can be optimized.

### FIELD OF THE INVENTION

The present invention relates to a converter circuit for converting an input signal to an output signal of a predetermined value based on a switched operating mode, and to a corresponding conversion method.

### BACKGROUND OF THE INVENTION

Regulated or controlled power supplies are found in virtually all electronic devices, including battery chargers, cellular telephones, computers, computer monitors, televisions, audio equipment and video cameras. One typical power supply is a converter, such as a direct current to direct current converter (in the following simply designated as DC converter), which operates from a power source, generates an alternating signal as an intermediate process and delivers an output signal to a load. The DC converter accepts a DC input voltage and produces a DC output voltage. Typically, the output voltage produced is at a different value or level than the input voltage.

In a typical pulse width modulation (PWM) regulator circuit, a square wave is provided to the control terminal of a switching device to control its on- and off-states. Since increasing the on-time of the switching device increases the output voltage and vice versa, the output voltage may be controlled by manipulating the duty cycle of the square wave. This manipulation is accomplished by a control circuit in a control loop, which continuously compares the output voltage to a reference voltage and adjusts the duty cycle of the square wave to maintain a substantially constant output voltage.

As an alternative, pulse frequency modulation (PFM) of the voltage regulation provides better efficiency at small output current levels than the above PWM mode. First, a PFM mode requires fewer turn-on transitions to maintain a constant output voltage than a PWM mode, thus resulting in lower gate-drive power dissipation of the switching transistor. Second, since the PFM mode can be achieved with a much simpler control circuit having fewer components, the power dissipation in a control loop of the PFM mode is less than that of the control loop of the PWM mode. However, when the output current reaches a moderate level, the PFM mode of voltage regulation becomes impractical, since the maximum output current available from the PFM mode is generally much less than that available from the PWM mode.

FIG. 1 shows a schematic block diagram of a conventional converter circuit which generates a regulated output voltage Vout from a variable input voltage Vin. The output voltage Vout can have a higher value than the input voltage Vin and is substantially constant, although the input voltage Vin and the output load may change. Such DC voltage converters usually use an inductor L to store energy generated by a current flowing through the inductor L and a switching device 20, which may be a power transistor or another controllable semiconductor switching device. The switching device 20 is used to switch off the respective current path, so that the energy stored in the inductor L is then transmitted as a current via a diode D to the output and charges a capacitor C connected in parallel with the output terminal. By continuously switching on and off the switching device 20, the energy stored in the inductor L is continuously transferred via the diode D to the capacitor C and charges the capacitor C. The diode D serves to provide decoupling between the voltage at the capacitor C and the voltage at the switching device 20, so that the output voltage Vout can be higher than the input voltage Vin. As already mentioned, the switching device 20 may be controlled in a PWM operating mode with a fixed frequency, wherein the duty cycle or the duration of the switching phase is controlled in order to substantially keep constant the output voltage Vout.

On the other hand, the switching device 20 may be operated in a PFM operating mode, wherein the switching frequency is changed in order to substantially keep the output voltage Vout constant. The switched operating mode is controlled by an oscillator and a driver circuit 10 which generates a corresponding control signal, such as a rectangular signal, supplied to the control terminal of the switching device 20.

The output voltage Vout is regulated or controlled by a feedback loop 40 which compares the value of the output voltage Vout with a reference voltage and then adjusts the switching frequency or duty cycle in accordance with the comparison result. In order to improve the efficiency of the converter, an additional switching device 30 may be provided at the diode D, or instead of the diode D, in order to remove the threshold voltage of the diode D. The additional switching device 30 may be controlled by a separate driver device or by the driver device 10 which controls the switching device 20.

In the following, a complete operating cycle of the DC converter is described by means of its three phases:

In a first phase, the switching device 20 is switched on and the additional switching device 30 is switched off, so that a current flows through the inductor L and the switching device 20 and energy is stored in the inductor L for one oscillator cycle.

In the second phase, the switching device 20 is switched off and the additional switching device 30 is switched on so that the current now flows to the capacitor C and energy is transmitted to the capacitor C.

In the third phase, the switching device 20 and also the additional switching device 30 are switched off, e.g. between the first and second phases or when the output voltage Vout has reached the correct or desired voltage value.

The output voltage Vout is controlled by the feedback loop 40 which allows or initiates the start of a new operating cycle if the output voltage Vout is too low, to thereby increase the switching frequency or the duty cycle. The switching phases must be carefully controlled by the driver device 10 in order to avoid the switching device 20 and the additional switching device 30 from being switched on simultaneously.

The amount of energy that can be transmitted to the output is directly linked to the inductance value of the inductor L and the switching period of the oscillator in the driver device 10. For a given inductance value and oscillator frequency, the desired output power can be delivered only for a limited input voltage range.

Document U.S. Pat. No. 5,945,820 discloses a DC converter with switching rate control using fixed-width pulses at an instantaneous switching rate. By altering the desired frequency the load communicates its power needs. A feedback arrangement computes from the desired frequency, the DC output voltage and the instantaneous switching rate a subsequent switching rate on the basis of which a chopping arrangement is operated for the voltage conversion.

### OBJECT AND SUMMARY OF THE INVENTION

It is an object of the present invention to provide a converter circuit and conversion method, by means of which a highly efficient conversion operation can be achieved over a wide range of input voltages.

The object of the invention is achieved by a converter circuit for converting an input signal to an output signal of a predetermined value based on a switched operating mode, said converter circuit comprising:
a first control loop for comparing said predetermined value of said output signal to a first reference value and for generating a feedback signal in response to the comparison result; and
a second control loop for comparing a time period until said feedback signal is generated to a second reference value and for controlling said switching parameter of said switched operating mode in response to the comparison result.

The object of the invention is furthermore achieved by a method of converting an input signal to an output signal of a predetermined value based on a switched operating mode, said method comprising:
a first comparing step for comparing said predetermined value of said output signal to a first reference value;
a generating step for generating a feedback signal in response to the result of said first comparing step;
a second comparing step for comparing a time period until said feedback signal is generated to a second reference value; and
a control step for initiating control of said switching parameter in response to the result of said second comparing step.

Accordingly, an additional second control loop is provided which automatically changes the switching parameter in case of any change at the converter input or output which leads to a change of the time period until the feedback signal is generated by the first control loop, i.e. until the predetermined value of the output signal is reached. As a result, the value of the output signal is correctly controlled or regulated not only with respect to the output load but also over a wide range of the value of the input signal. Power efficiency and reliability of the conversion scheme can thus be optimized. Moreover, an optimum value of the switching parameter is automatically set, which makes the conversion process less sensitive to any spread of the parameter or component value, e.g. input voltage, inductance, output capacitance etc., and less sensitive to parasitic components such as wiring resistance, i.e., resistance of connections between components. An additional terminal or input voltage supervising means is therefore not required.

In particular, the predetermined value may be a voltage value of the output signal. Thereby, an improved DC voltage converter can be obtained, as a specific example of the proposed dual loop converter circuit.

The second control loop may comprise determination means for determining the number of operating cycles that have been completed without reaching the second reference value. The determination of a number of operating cycles can be easily derived from the switching operation of the converter circuit without requiring any additional clock signal for a digital timer or any complex analog time measuring circuit. Thereby, the number and complexity of the circuit components required for the second control loop can be kept low.

The switching parameter may be an operating frequency of the switched operating mode. The use of the operating frequency as the switching parameter provides the advantage of a simple driver device with a simple controllable oscillator, such as a voltage-controlled oscillator.

As an example, the second control loop may be adapted to control a frequency divider means, used for generating the operating frequency, in a manner to increase a frequency division ratio of the frequency divider means if the determined number of operating cycles exceeds a predetermined number associated with a second reference value. Hence, if the determined number of operating cycles exceeds the predetermined number, the frequency division ratio is increased and therefore the operating frequency is reduced in order to increase the duration of the initially mentioned first phase. Therefore, more energy is stored in the inductance and thus more energy is made available to be transmitted to the output. Additionally, the determination means may comprise a second counter means whose counting operation is controlled by the control signal of the first counter means, wherein the counting direction of the second counter means may be controlled based on an output value obtained from the first counter means at the time when the feedback signal is generated by the first control loop. Each control signal from the first counter is thus counted by the second counter, increasing or decreasing the output value of the second counter which can be used to control the switching frequency, e.g., by controlling the frequency division ratio of the frequency divider means in accordance with the output value of the second counter value means.

Furthermore, the second control loop may be adapted to indicate an overload condition if the frequency division ratio has reached a predetermined maximum ratio. As an example, this indication may be derived from a carry output of the second counter means, which is generated when a predetermined value is reached. Thereby, excessive conducting cycles of the switching devices, which may be detrimental, can be avoided. Moreover, this measure provides protection against the use of wrong values for the inductance, input voltage or output load.

The frequency division ratio may be stored in a memory means of the second control means, when the second reference value has been reached within the predetermined number of operating cycles. Thus, the frequency division ratio is memorized when the correct output value is reached.

Furthermore, sequencer means may be provided for allowing control of the switching parameter only after completion of an operating cycle. This ensures that the operating cycle is always correctly finished and that there is no detrimental effect on the output signal due to a phase change.

### BRIEF DESCRIPTION OF THE DRAWINGS

The present invention will now be described based on a preferred embodiment with reference to the accompanying drawings which may not be construed as limiting the broad scope of the invention, and in which:

FIG. 1 shows a schematic block diagram of a conventional DC converter circuit;

FIG. 2 shows a schematic block diagram of a DC converter circuit according to the preferred embodiment;

FIG. 3 shows a schematic block diagram of an implementation example of the second feedback loop according to the preferred embodiment; and

FIG. 4 shows waveform diagrams of characteristic signals obtained from an implementation example.

### DESCRIPTION OF EMBODIMENTS

The preferred embodiment will now be described on the basis of a DC converter which may be used in an integrated circuit for generating power supply for electronic devices, such as a smart card.

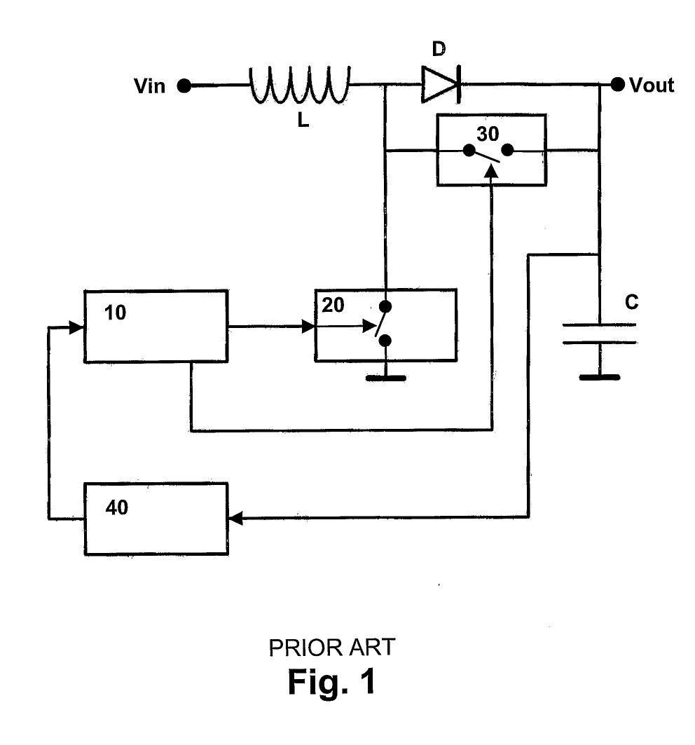

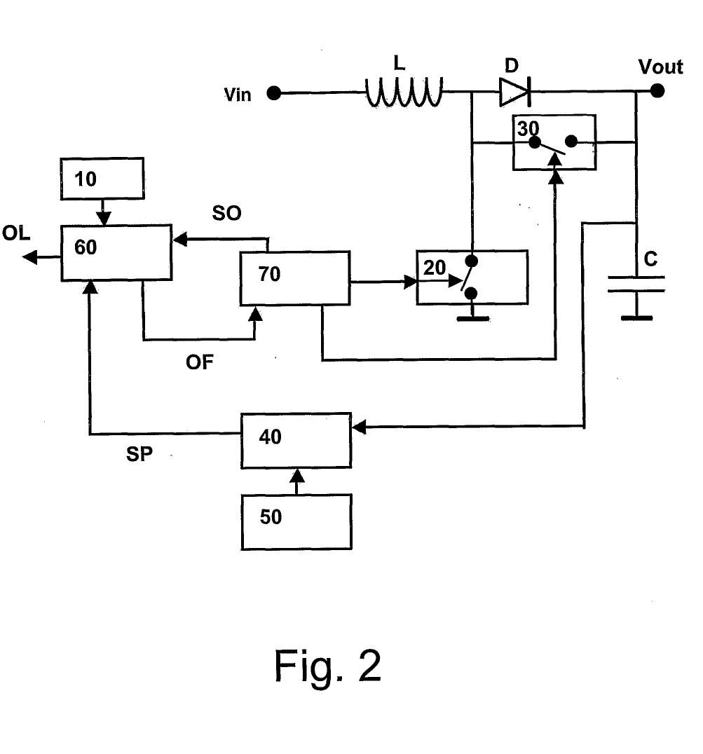

FIG. 2 shows a schematic block diagram of the DC converter according to the preferred embodiment. In addition to the conventional circuit of FIG. 1, the preferred embodiment comprises an additional second control loop 60 which compares a time period required until a desired output voltage Vout has been reached to a predetermined reference value and subsequently performs a control operation to change the operating frequency OF based on the comparison result. In the specific example of the preferred embodiment described herein, the second control loop 60 is arranged to count the number of operating cycles until the desired output voltage Vout has been reached and increase the operating frequency OF when the counting result is lower than the first value and reduce the operating frequency OF when the counting result exceeds a second value.

When the efficiency and the output current capability of the DC converter are studied in dependence on the operating frequency OF, it becomes clear that a change of the operating frequency OF may lead to a higher efficiency, provided the current load situation allows such a change. For instance, the maximum output load may be 70 mA at an operating frequency OF of 1.6 MHz with an efficiency of about 60%. If more output current is needed, the frequency must be reduced at the expense of less efficiency. However, if less output current is needed, it is better to operate the DC converter at a higher operating frequency OF to achieve better efficiency. If the values of the inductance L, the output capacitor C or the input voltage Vin change, the behaviour of the DC converter remains the same, but the optimum operating frequency OF may be different. Therefore, in order to obtain the desired output voltage Vout with the best efficiency for a wide output load variation and input voltage variation, the output frequency of the oscillator 10 is adjusted by the second feedback loop 60 which monitors the behaviour of the drivers for the switching device 20 and also takes into account information given by the first feedback loop 40. A sequencer 70 is provided for maintaining correct operating cycles, i.e. allowing control of the operating frequency OF only after completion of an operating cycle, i.e. at the beginning of a new operating cycle.

At first oscillator 10 is set to the highest operating frequency OF and the second feedback loop 60 acts as a frequency divider and adjusts the operating frequency OF of the switching device 20. Therefore, the DC converter always starts operating at the highest operating frequency OF, which leads to the maximum efficiency. The second feedback loop 60 checks the driver status and the output of the first feedback loop 40 in order to count the number of operating cycles which have been completed without reaching the correct output voltage value Vout. This is achieved based on a stop pump signal SP output from the first feedback loop 40 when the output voltage Vout has reached a reference voltage supplied by a reference voltage generator 50.

It is noted that the basic functionality of the switching device 20, the driver device with the oscillator 10, the additional switching device 30 and the first feedback loop 40 basically corresponds to the conventional circuit described in connection with FIG. 1, so that a description of these parts of the circuit can be omitted here for reasons of brevity.

If the number of operating cycles determined by the second feedback loop 60 exceeds a preset value, a frequency division ratio applied in the second feedback loop 60 to the output frequency of the oscillator 10 is increased and therefore the operating frequency OF delivered to the sequencer 70 is reduced in order to increase the duration of the first phase of the DC converter and thus store more energy in the inductance L so as to increase the energy available to be transmitted to the output.

The second feedback loop 60 is reset and restarts counting operating cycles based on a switch-on SO signal generated by the sequencer 70 when the switching device 20 is conducting, which means that a new operating cycle is started. The frequency division ratio is increased again in the second feedback loop 60, if the output value is not reached. Finally, for a certain operating frequency OF, the output voltage value will be reached as indicated by the stop pump signal SP output from the first feedback loop 40. Then, the highest possible operating frequency OF has been reached, ensuring the best efficiency at the current output load, input voltage, inductance and other converter parameters.

Additionally, a minimum operating frequency, i.e. a maximum frequency division ratio, can be set by the second feedback loop 60 in order to avoid too long or excessive conducting cycles of the switching device 20, which may damage the switching device 20. This measure can be used as a protection against wrong values for the inductance L, the input voltage Vin or the output load. In particular, when this minimum frequency has been reached, a signal can be issued by the second feedback loop 60 as a warning of bad operating conditions, e.g. an overload signal OL. When the correct output voltage value has been reached, the frequency division ratio may be memorized at the second feedback loop 60.

When the second feedback loop 60 has counted only one operating cycle before the correct output voltage value has been reached, the frequency division ratio is reduced to thereby increase the operating frequency OF. Thereby, the DC converter can be adapted to any output load or other parameter change and ensure best efficiency.

The DC converter according to the preferred embodiment, which uses the second feedback loop 60, automatically changes its operating frequency OF in case of any change of the input or output situation of the DC converter. The output voltage Vout can thus be correctly controlled not only with respect to the output load conditions but also over a wide voltage range. This leads to an optimized power efficiency and reliability of the DC converter. Moreover, the protection of the switching device 20 is achieved by detecting overload conditions. The proposed DC converter automatically finds the best operating frequency OF, which makes the DC converter less sensitive to any spread of the parameter component values, e.g. input voltage Vin, inductance L, output capacitance C and the like, and less sensitive to parasitic components like wiring resistance. Consequently, additional terminals or circuits for supervising or monitoring input conditions or parameter or component values are not required.

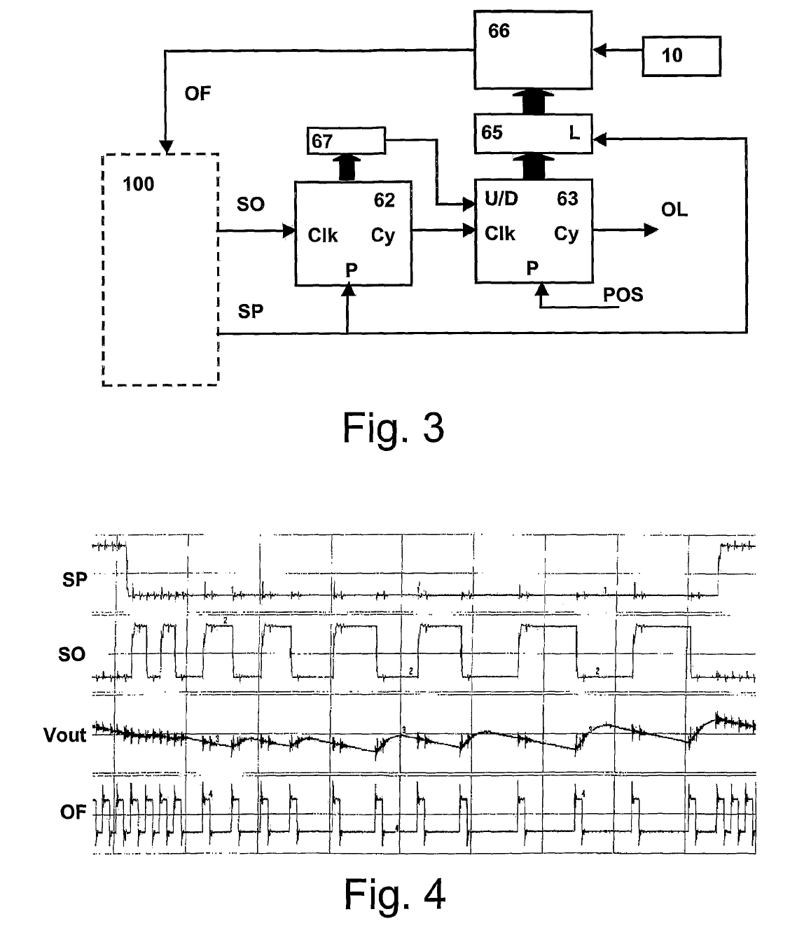

In the following, an implementation example of the second feedback control loop 60 is described with reference to FIG. 3.

FIG. 3 shows a schematic block diagram of the second feedback loop 60. This second feedback control loop 60 can be used in any DC converter where an output value needs to be regulated against any parameter or application change to optimize circuit efficiency. As an example, it can be used in connection with a DC converter integrated in a circuit that generates power supply for electronic devices, such as smart cards. The present example shown in FIG. 3 can be implemented in a programmable digital array which comprises the oscillator 10 of the DC converter.

In particular, the second feedback loop 60 operates based on two input signals generated by the remaining circuitry 100 of the DC converter, including the sequencer 70 which may comprise the drivers of the switching device 20. As already mentioned, the input signals comprise the switch-on signal SO generated by the sequencer 70 and the stop pump signal SP generated by the first control loop 40. The stop pump signal SP indicates that the output voltage Vout has reached its correct value, which means that no additional operating cycle is needed.

The second feedback control loop 60 provides a variable operating frequency OF to the remaining circuit 100 of the DC converter. In the specific implementation example shown in FIG. 3, the second feedback loop 60 comprises a first counter 62 which counts the number of operating cycles based on the switch-on signal SO which is supplied to a clock terminal Clk of the first counter 62. A preset value is set in the first counter 62 when the stop pump signal SP is generated and supplied to a preset terminal P of the first counter 62. Thus, the first counter 62 counts the number of operating cycles up to the preset value and outputs control of carry signals Cy when the preset value has been reached. Thus, when the carry signal Cy is output, this means that the stop pump signal SP has not indicated that the output voltage Vout is correct and therefore a decrease of the operating frequency OF is required. The first counter 62 acts as a frequency divider with a preset division ratio. It is preset to a predetermined value, e.g. the value “4”, each time the stop pump signal SP is set to an active state, e.g. a high logical level, which determines the number of operating cycles to be completed before a change of the operating frequency OF is carried out.

Each carry signal generated by the first counter 62 is supplied to a clock input of a second counter 63 and is thus counted by the second counter 63. A decoder circuit 67 receives the output value of the first counter 62 when the stop pump signal SP indicates that the output voltage Vout is correct. Based on this output signal, the decoder circuit 67 generates a direction control signal to control the counting direction (up or down) for the counting operation of the second counter 63. For instance, if the output value of the first counter 62 is equal to “1” when the stop pump signal SP is active, this means that the operating frequency OF is too low and the frequency division ratio must be decreased, and vice versa. Thus, the output value of the second counter 63 is increased or decreased from a value preset when the power is switched on, as indicated by a power-on-reset signal POS supplied to a preset terminal P of the second counter 63.

The output value of the second counter 63 is supplied via a memory or a transparent latch 65 to a programmable frequency divider 66 which sets its frequency division ratio based on the output value of the second counter 63. The transparent latch 65 memorizes the output signal of the second counter 63 and thus the frequency division ratio when the stop pump signal SP indicates that the output voltage is correct.

A second carry signal Cy generated by the second counter 63 can be used as the overload signal OL. When this carry signal is output, it means that the second counter 63 has reached its maximum value and the operating frequency OF is at its lowest value, while the output voltage Vout is still not correct. In this case, the current flowing through the switching device 20 may be too high, if the operating frequency OF is too low. This detrimental situation is indicated by the overload signal OL.

In summary, the frequency division ratio of the programmable frequency divider 66 is changed in order to get the best efficiency of the DC converter. The frequency of the output signal of the oscillator 10 is divided by a frequency division ratio associated with or corresponding to the output value of the second counter 63. The output signal of the programmable frequency divider 66 corresponds to the operating frequency OF supplied to the DC converter. It is noted that the second feedback loop 60 may be implemented with standard digital circuits or as a software routine controlling a processing device or a digital single processor.

FIG. 4 shows a signaling diagram indicating respective waveforms of the stop pump signal SP, the switch-on signal SO, the output voltage Vout, and the operating frequency OF. As can be gathered from FIG. 4, the stop pump signal SP is at a low level and thus in an inactive state throughout the period shown in FIG. 4 and changes to an active state at the end of the indicated time period, which means that the output voltage Vout has reached the correct value at the end of the time period indicated in FIG. 4. Moreover, from the waveform of the switch-on signal SO it can be seen that the control of the second feedback loop 60 leads to a decrease of the operating frequency OF, which lengthens the conducting periods of the switching device 20 and thus increases the energy stored in the inductance L. This continuous increase of the energy available to be supplied to the output leads to a continuous increase in output voltage Vout, which shows an exponential behaviour due to the charging and discharging of the output capacitance C. The waveform of the operating frequency OF indicates that the frequency is changed after every four operating cycles, which means that the preset value of the first counter 62 has been set to “4”. Furthermore, as can be gathered from the waveform of the operating frequency OF, the frequency is reduced after every four operating cycles by increasing the frequency division ratio of the programmable frequency divider 66, until the output voltage Vout has reached the correct value as indicated by the stop pump signal SP at the upper right portion of the signaling diagram. When the stop pump signal SP has returned to the active state, the operating frequency OF is increased again.

It is noted that the present invention is not restricted to the above-described, preferred embodiment but can be used in any converter circuit where a switched operating mode is used for converting an input signal to an output signal of a predetermined value. Moreover, the proposed additional control loop can be used in all kinds of converter circuits, such as step-down buck converters, step-up boost converters, buck-boost converters, CUK converters, isolated DC converters, flyback converters, forward converters and current converters, which are all based on a switched operating mode. Preferred embodiments may thus vary within the scope of the attached claims.

It must further be noted that the term “comprising”, when used in the specification including the claims, is intended to specify the presence of stated features, means, steps or components, but does not exclude the presence or addition of one or more other features, means, steps, components or groups thereof. Furthermore, the word “a” or “an” preceding an element in a claim does not exclude the presence of a plurality of such elements. Moreover, any reference sign does not limit the scope of the claims. The invention can be implemented by means of both hardware and software, and several “means” may be represented by the same item or hardware.

At this point it is also noted that the features of the invention, which features appear alone or in combination, can also be combined or separated so that the large number of variations and applications of the invention can be easily imagined.

1. A converter circuit for converting an input signal to an output signal of a predetermined value based on a switched operating mode, said converter circuit comprising:
a) a first control loop for comparing said predetermined value of said output signal to a first reference value and for generating a feedback signal in response to the comparison result; and
b) a second control loop for comparing a time period until said feedback signal is generated to a second reference value and for controlling said switching parameter of said switched operating mode in response to the comparison result.

2. A converter circuit according to claim 1, wherein said predetermined value is a voltage value of said output signal.

3. A converter circuit according to claim 1, wherein said second control loop comprises determination means for determining the number of operating cycles that have been completed without reaching said second reference value.

4. A converter circuit according to claim 3, wherein said switching parameter is an operating frequency of said switched operating mode.

5. A converter circuit according to claim 4, wherein said second control loop is adapted to control a frequency divider means used for generating said operating frequency, in a manner to increase a frequency division ratio of said frequency divider means if said determined number of operating cycles exceeds a predetermined number associated with said second reference value.

6. A converter circuit according to claim 5, wherein said determination means comprises first counter means counting said operating cycles and for outputting a control signal if said predetermined number has been reached, said counting means being reset when said feedback signal is generated by said first control loop.

7. A converter circuit according to claim 6, wherein said determination means comprises a second counter means whose counting operation is controlled by said control signal of said first counter means the counting direction of said second counter means being controlled based on an output value obtained from said first counter means at the time when said feedback signal is generated by said first control loop.

8. A converter circuit according to claim 7, wherein said frequency division ratio of said frequency divider means is controlled in accordance with an output value of said second counter means.

9. A converter circuit according to any one of claims 5 to 8, wherein said second control loop is adapted to indicate an overload condition if said frequency division ratio has reached a predetermined maximum ratio.

10. A converter circuit according to claim 5, wherein said frequency division ratio is stored in a memory means of said second control loop when said second reference value has been reached within said predetermined number of operating cycles.

11. A converter circuit according to claim 1, wherein said conversion is based on at least one switched inductance.

12. A converter circuit according to claim 1, further comprising sequencer means for allowing control of said switching parameter only after completion of an operating cycle.

13. A method of converting an input signal to an output signal of a predetermined value based on a switched operating mode, said method comprising:
a) a first comparing step for comparing said predetermined value of said output signal to a first reference value;
b) a generating step for generating a feedback signal in response to the result of said first comparing step;
c) a second comparing step for comparing a time period until said feedback signal is generated to a second reference value; and
d) a control step for initiating control of said switching parameter in response to the result of said second comparing step.
